(19) United States
(12) Patent Application Publication
(10) Pub. No.: US 2025/0031811 A1
(43) Pub. Date: Jan. 30, 2025

(54) WATCHBAND FOR SMART WATCH, AND SMART WATCH COMPRISING SAME

(71) Applicant: AMOGREENTECH CO., LTD., Gimpo-si, Gyeonggi-do (KR)

(72) Inventors: Seung Yun RHO, Gimpo-si, Gyeonggi-do (KR); Sang Dong JEONG, Gimpo-si, Gyeonggi-do (KR)

(73) Assignee: AMOGREENTECH CO., LTD., Gimpo-si, Gyeonggi-do (KR)

(21) Appl. No.: 18/715,909

(22) PCT Filed: Nov. 23, 2022
(86) PCT No.: PCT/KR2022/018587

§ 371 Date: Jun. 3, 2024

(30) Foreign Application Priority Data
Dec. 3, 2021 (KR) 10-2021-0171534

(51) Int. Cl. A44C 5/00; H01M 50/105; H01M 50/247; H02J 7/00

(52) U.S. Cl. CPC A44C 5/0084; H01M 50/105; H01M 50/247; H02J 7/0045

(57) ABSTRACT

A watchband for a smart watch is provided. The watchband for a smart watch includes: a first band having at least one positioning hole; and a second band including a cover member, a flexible battery, and a position-fixing fastening member, wherein an exterior material of the flexible battery can include a first portion for packing the electrode assembly together with the electrolyte, and a second portion extended from the first portion by a predetermined and to which the position-fixing fastening member is coupled.

### CROSS REFERENCE TO THE RELATED APPLICATIONS

This application is the national phase entry of International Application No. PCT/KR2022/018587, filed on Nov. 23, 2022, which is based upon and claims priority to Patent Application No. 10-2021-0171534, filed in the Republic of Korea on Dec. 3, 2021, the entire contents of which are incorporated herein by reference.

### TECHNICAL FIELD

The present invention relates to a watchband for a smartwatch, and a smartwatch including the same.

### BACKGROUND

A smartwatch refers to an embedded system wristwatch that includes more advanced functions than regular watches. Such a smartwatch may include a touch screen, a heart rate sensor, a communication module, a GPS function, etc., and may be linked to a portable device such as a smartphone or a tablet PC.

Accordingly, the user can easily use not only the functions of the smartwatch but also some functions of the portable device while wearing the smartwatch on the wrist.

However, since the smartwatch is a wearable device worn on the user's wrist, it has a limitation on the overall size and is inevitably implemented in a relatively small size compared to a portable device such as a smartphone or a tablet PC.

Accordingly, the conventional smartwatch has a limitation in that the usage time is short because a battery with a small capacity is bound to be built in the main body due to size constraints.

### SUMMARY OF THE INVENTION

The present invention has been devised in view of the above points, and an object of the present invention is to provide a watchband for a smartwatch that can provide driving power for increasing the usage time of the smartwatch, and a smartwatch including the same.

In order to solve the above-described problems, the present invention provides a watchband for a smartwatch including: a first band made of a soft material having flexibility, formed from a plate-shaped member having a predetermined length, and having at least one positioning hole formed therethrough; and a second band including a cover member made of a soft material having flexibility, a flexible battery formed in a plate shape having a predetermined length and a predetermined area and embedded in the cover member, and a position-fixing fastening member fastened to the positioning hole, wherein the flexible battery includes an electrode assembly, and an exterior material for packing the electrode assembly together with an electrolyte, wherein the exterior material includes a first portion for packing the electrode assembly together with the electrolyte, and a second portion extended from the first portion by a predetermined length and to which the position-fixing fastening member is coupled.

In addition, the cover member may be provided to cover both outer surfaces of the first portion and the second portion, and the thickness of a portion corresponding to the flexible battery among the entire length of the second band may be provided to have a constant thickness.

Additionally, the second band may include a fastening hole for fastening the position-fixing fastening member, wherein the fastening hole may be formed to penetrate both the cover member and the second portion of the flexible battery.

Further, the exterior material may include a first exterior material covering the upper surface of the electrode assembly and a second exterior material covering the lower surface of the electrode assembly, wherein the first exterior material and the second exterior material may be attached to each other through an adhesive layer disposed on one surface of each exterior material facing each other, wherein the adhesive layer may be disposed to surround an edge of the electrode assembly disposed between the first exterior material and second exterior material.

In addition, the second portion may function as a shape-maintaining member to maintain the shape of the cover member and as a position-fixing member to prevent the position of the flexible battery built in the cover member from being changed inside the cover member.

Additionally, the second band may further include a connection terminal provided at one end to electrically connect the flexible battery and the main body of the smartwatch.

Additionally, the second band may further include a charging terminal for electrical connection to a charging cradle to recharge the flexible battery.

Additionally, the charging cradle may include a body and a protruding terminal protruding outward from one surface of the body, wherein the protruding terminal may be a pogo pin that contacts the charging terminal when the second band and the body are coupled.

Additionally, a protruding member and an accommodating groove corresponding to each other may be formed on one surface of the second band and one surface of the body facing each other when the second band and the body are coupled, respectively.

In addition, the flexible battery may include a first pattern formed on the electrode assembly and a second pattern formed on the exterior material, wherein each of the first pattern and the second pattern may be formed such that peaks and valleys are repeatedly arranged along a longitudinal direction of the flexible battery, and the first pattern and the second pattern may be disposed such that the peak and the valley coincide with each other.

Meanwhile, the present invention provides a smartwatch including: a main body comprising a display unit displaying at least one piece of information; and a band part connected to the main body and for maintaining a state in which the main body is worn on the user's wrist, wherein the band part is a watchband for a smartwatch as described above, and the main body receives driving power from the flexible battery.

According to the present invention, driving power can be provided to the smartwatch main body even without changing the design of the smartwatch main body, thereby increasing the total usage time of the smartwatch.

### BRIEF DESCRIPTION OF THE DRAWINGS

FIG. 1 is a diagram showing a watchband for a smartwatch according to an embodiment of the present invention.

FIG. 2 is a view showing a portion of a second band cut along line A-A in FIG. 1.

FIG. 3 is a schematic diagram showing a flexible battery applied to a watchband for a smartwatch according to an embodiment of the present invention.

FIG. 4 is a view showing a state in which an exterior material and an electrode assembly in FIG. 3 are separated.

FIG. 5 is a view showing a second band in FIG. 1 viewed from a different direction.

FIG. 6 is a diagram showing a state in which a second band is coupled to a charging cradle in a watchband for a smartwatch according to an embodiment of the present invention.

FIG. 7 is a diagram showing a connection relationship between a second band and a charging cradle in a watchband for a smartwatch according to an embodiment of the present invention.

FIG. 8 is a partially separated view of a charging cradle that can be applied to a smartwatch according to an embodiment of the present invention.

FIG. 9 is a diagram showing a smartwatch according to an embodiment of the present invention.

FIG. 10 is a diagram showing a state in which a second band in FIG. 9 is separated.

FIG. 11 is a diagram showing a connection relationship between a main body and a second band in a smartwatch according to an embodiment of the present invention.

FIG. 12 is a diagram showing a state in which a smartwatch according to an embodiment of the present invention is coupled to a charging cradle.

### DETAILED DESCRIPTION

Hereinafter, with reference to the accompanying drawings, embodiments of the present invention will be described in detail so as to be easily implemented by one of ordinary skill in the art to which the present invention pertains. The present invention may be embodied in a variety of forms and is not limited to the embodiments described herein. In order to clearly describe the present invention in the drawing, parts irrelevant to the description are omitted from the drawings; and throughout the specification, same or similar components are referred to as like reference numerals.

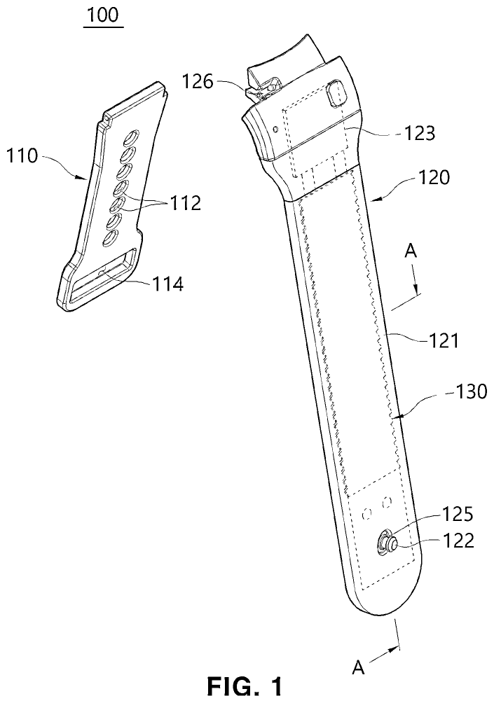

A watchband 100 for a smartwatch according to an embodiment of the present invention includes a first band 110 and a second band 120, as shown in FIG. 1.

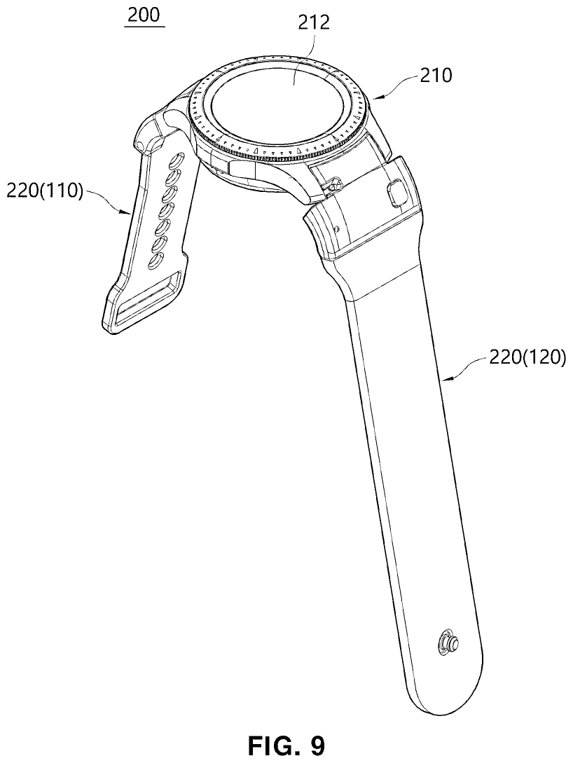

As shown in FIG. 9, one end of each of the first band 110 and the second band 120 may be fastened to the main body 210 of the smartwatch 200, and may be fastened to each other through corresponding fastening means.

Accordingly, a user can wear the main body 210 of the smartwatch 200 on the body (for example, wrist) by fastening the first band 110 and the second band 120 to each other through the fastening means.

For example, the fastening means may include: a plurality of positioning holes 112 formed in the first band 110 to be spaced apart from each other along a longitudinal direction of the first band 110, and a position-fixing fastening member 122 provided on the second band 120 so that it can be selectively fastened to any one of the plurality of positioning holes 112.

As a non-limiting example, the positioning hole 112 may be a through hole formed to penetrate the first band 110, and the position-fixing fastening member 122 may be a known metal buckle protruding from one surface of the first band 110 by a certain length so that it can be inserted into the positioning hole 112.

In this case, the first band 110 and the second band 120 may be made of a rigid material, but may be made of a soft material so that they can be flexibly deformed to fit the user's wrist while increasing the user's wearing comfort.

That is, the first band 110 may be made of a soft material having flexibility, and may be formed in a plate shape with a predetermined length and area so that the plurality of positioning holes 112 can be formed along the longitudinal direction.

In addition, the second band 120 may include a cover member 121 made of a soft material having flexibility, and the position-fixing fastening member 122 may be provided in the second band 120 so that one end thereof protrudes outward from one surface of the cover member 121.

As a non-limiting example, the first band 110 and the cover member 121 may be made of known materials such as silicone, PU, TPU, etc., but are not limited thereto, and may be made of any various known materials as long as they are soft materials with flexibility.

Accordingly, the user can bend the first band 110 and the second band 120 respectively connected to both sides of the main body 210 to surround the user's wrist, and when the position-fixing fastening member 122 is inserted into any one of the plurality of positioning holes 112, the entire lengths of the first band 110 and the second band 120 fastened to each other can be adjusted to fit around the user's wrist.

Herein, the first band 110 may include an opening 114 formed therethrough with a predetermined area so that a portion of the total length of the second band 120 can pass through it.

In this case, the second band 120 may function as a power supply source that provides driving power to the main body 210 of the smartwatch 200 while one end of the second band 120 is fastened to the main body 210.

That is, when a battery is embedded in the main body 210, the second band 120 may serve as an auxiliary battery to assist the battery. Accordingly, when the watchband 100 for a smartwatch according to an embodiment of the present invention is fastened to the main body 210 of the smartwatch, the main body 210 can additionally receive driving power from the second band 120 together with the built-in battery. Accordingly, the main body 210 uses the power provided from the second band 120, thereby increasing the usage time.

However, the role of the second band 120 is not limited to thereto, and if the main body 210 does not have a built-in battery, the second band 120 may serve as a main battery that provides driving power to the main body 210.

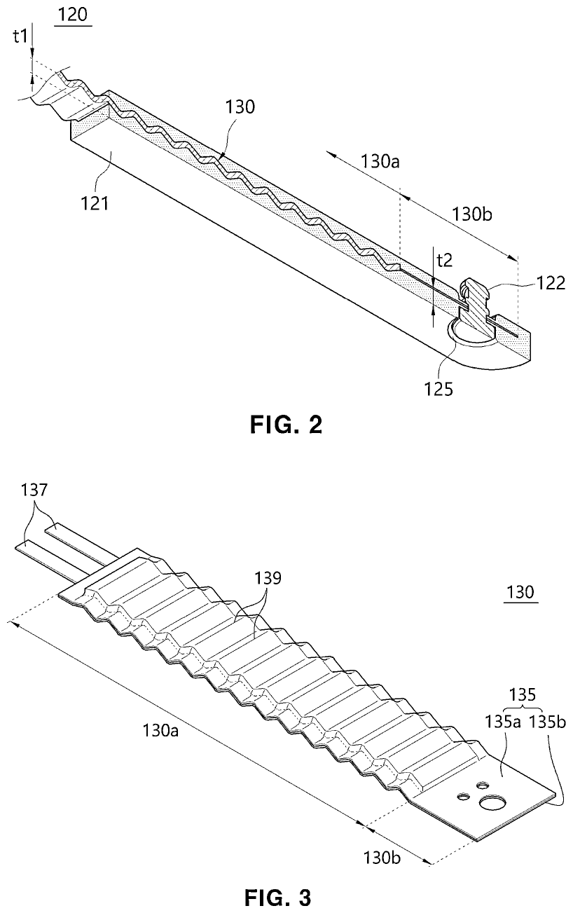

To this end, as shown in FIGS. 1 and 2, the second band 120 may include a flexible battery 130 built in the cover member 121, and a pair of connection terminals 124 provided at one end to electrically connect the flexible battery 130 to the main body 210.

In this case, the flexible battery 130 may be formed in a plate shape with a predetermined length and a predetermined area so as to have a high storage capacity while reducing the overall weight.

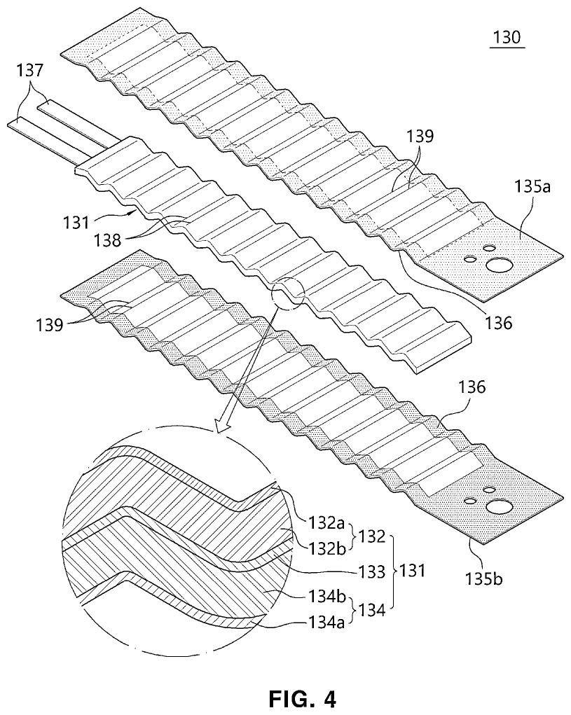

For example, as shown in FIGS. 3 and 4, the flexible battery 130 may include an electrode assembly 131 and an exterior material 135, wherein the electrode assembly 131 and the exterior material 135 may be formed in a plate shape with a predetermined area.

Additionally, the electrode assembly 131 may be packed inside the exterior material 135 together with an electrolyte, and as shown in FIG. 3, the flexible battery 130 may include a pair of electrode terminals 137 provided to be exposed from the electrode assembly 131 to the outside of the exterior material 135.

In this case, the second band 120 may further include a circuit board 123 embedded in the cover member 121 as shown in FIG. 1, wherein the circuit board 123 may be electrically connected to the pair of electrode terminals 137 and the pair of connection terminals 124, respectively.

Accordingly, power provided from the flexible battery 130 may be provided to the main body 210 of the smartwatch 200 through the electrode terminal 137, the circuit board 123, and the connection terminal 124.

In this case, the exterior material 135 may include a first portion 130a for packing the electrode assembly 131 with an electrolyte, and a second portion 130b extending from the first portion 130a by a predetermined length and to which the position-fixing fastening member 122 is coupled.

In this case, the first portion 130a may accommodate the electrode assembly 131 and the electrolyte therein, and the second portion 130b may not accommodate the electrode assembly 131 and the electrolyte.

Accordingly, the first portion 130a may have a thicker thickness than the second portion 130b, and the position-fixing fastening member 122 may be directly coupled to the second portion 130b that does not accommodate the electrode assembly 131 and the electrolyte in the flexible battery 130.

Therefore, the second portion 130b may function as a shape-maintaining member to maintain the shape of the cover member even if the cover member 121 is made of a soft material having flexibility, and as a position-fixing member to prevent the position of the flexible battery 130 built in the cover member 121 from being changed inside the cover member 121.

To this end, as shown in FIG. 1, the cover member 121 may be provided to cover all outer surfaces of the first portion 130a and the second portion 130b, and the second band 120 may include a fastening hole 125 for fastening the position-fixing fastening member 122, as shown in FIG. 2, and the fastening hole 125 may be formed to penetrate both the cover member 121 and the second portion 130b.

Further, as shown in FIG. 4, the exterior material 135 may include a first exterior material 135a covering the upper surface of the electrode assembly 131 and a second exterior material 135b covering the lower surface of the electrode assembly 131, wherein the first exterior material 135a and the second exterior material 135b may be attached to each other through an adhesive layer 136 disposed on one surface of each exterior material facing each other, wherein the adhesive layer 136 may be disposed to surround the entire edge of the electrode assembly disposed between the first and second exterior materials 135a and 135b.

Herein, the exterior material 135 may include a dense metal layer to prevent moisture and electrolyte from passing through. For example, the exterior material may include a foil-type metal sheet, wherein the metal sheet may include at least one selected from aluminum, copper, phosphorbronze (PB), aluminum bronze, cupronickel, chromium-copper, titanium-copper, iron-copper, Corson alloy, and chromium-zirconium copper alloy.

Accordingly, when the position-fixing fastening member 122 is coupled to the fastening hole 125 formed in the second portion 130b while the flexible battery 130 is embedded in the cover member 121, the flexible battery 130 can be prevented from changing its position within the cover member 121 through the position-fixing fastening member 122.

In addition, even if the fastening hole 125 is formed to completely penetrate the cover member 121 made of a soft material, the fastening hole 125 can be formed to be located in the second portion 130b of the flexible battery 130, whereby a portion of the entire length of the cover member 121 including a part where the fastening hole 125 is formed can maintain the shape through the second portion 130b including the metal layer.

In addition, even if the fastening hole 125 is formed to penetrate both the cover member 121 and the second portion 130b, there is no risk that the electrode assembly 131 is damaged by the fastening hole 125, so the flexible battery 130 can perform its function smoothly.

In the present invention, the electrode assembly 131 may include a positive electrode 132, a negative electrode 134, and a separator 133 as shown in FIG. 4, wherein the positive electrode 132 may include a positive electrode current collector 132a and a positive electrode active material 132b, and the negative electrode 134 may include a negative electrode current collector 134a and a negative electrode active material 134b.

In addition, the pair of electrode terminals 137 may be formed to extend a certain length from the positive electrode current collector 132a and the negative electrode current collector 134a, respectively, and the separator 133 may be disposed to be located between the positive electrode 132 and the negative electrode 134.

Since the positive electrode 132, negative electrode 134, and separator 133 are known in the art, detailed descriptions thereof will be omitted, and all general contents commonly used in batteries may be applied.

Meanwhile, as described above, in the flexible battery 130, the first portion 130a accommodates the electrode assembly 131 and the electrolyte therein, so the first portion 130a may have a thicker thickness than the second portion 130b. In this case, as shown in FIG. 2, the thickness (t1) of the cover member 121 covering the first portion 130a may have a thinner thickness than the thickness (t2) of the cover member 121 covering the second portion 130b.

For example, the thickness (t1) of the cover member 121 covering the upper surface of the first portion 130a may be thinner than the thickness (t2) of the cover member 121 covering the upper surface of the second portion 130b, and the thickness (t1) of the cover member 121 covering the lower surface of the first portion 130a may be thinner than the thickness (t2) of the cover member 121 covering the lower surface of the second portion 130b. Accordingly, in a state in which the cover member 121 covers all the outer surfaces of the first portion 130a and the second portion 130b, a portion of the entire length of the second band 120 in which the flexible battery 130 is embedded may be formed to have a constant thickness.

Therefore, even if the flexible battery 130 embedded in the cover member 121 includes a first portion 130a and a second portion 130b having different thicknesses, the thickness difference between the first portion 130a and the second portion 130b in the second band 120 can be supplemented by the cover member 121, thereby preventing the aesthetics from being deteriorated.

In this case, the flexible battery 130 according to an embodiment of the present invention may be formed in a flat plate shape, but may further include patterns 138 and 139 in which peaks and valleys are repeatedly arranged along the longitudinal direction as shown in FIGS. 3 and 4.

Such patterns 138 and 139 can prevent performance degradation of the flexible battery 130 and damage to the flexible battery 130 when the flexible battery 130 is bent.

To this end, the patterns 138 and 139 may include a first pattern 138 formed on the electrode assembly 131 and a second pattern 139 formed on the exterior material 135, as shown in FIG. 4, wherein the first pattern 138 and the second pattern 139 may be arranged so that the peaks and valleys coincide with each other.

That is, the first pattern 138 may be formed so that the peaks and the valleys are repeatedly arranged along the longitudinal direction of the electrode assembly 131, and the second pattern 139 may be formed so that the peaks and the valleys are repeatedly arranged along the longitudinal direction of the exterior material 135.

In addition, the first pattern 138 and the second pattern 139 may be formed so that the peaks are positioned at the same position as each other, and the valleys are positioned at the same position as each other.

Therefore, even if the flexible battery 130 according to an embodiment of the present invention is bent, or bent with a predetermined curvature and returned to its original state, the amount of change in length can be offset through the first pattern 138 and the second pattern 139 formed to match each other.

Accordingly, even if the flexible battery 130 according to an embodiment of the present invention undergoes repetitive bending or is installed in a bent state with a predetermined curvature, the amount of deformation of the substrate itself that may occur locally in the bent portion can be minimized. As a result, the flexible battery 130 according to an embodiment of the present invention can be prevented from being locally damaged or deteriorating in performance at a portion where the electrode assembly 131 and the exterior material 135 are bent.

Meanwhile, as described above, the second band 120 may include a pair of connection terminals 124 provided at one end to electrically connect the flexible battery 130 to the main body 210 while being fastened to the main body 210 of the smartwatch.

In addition, the second band 120 may further include a coupling member 126 to maintain a state of being fastened with the main body 210 of the smartwatch.

For example, the pair of connection terminals 124 may be provided so that the overall length can be varied through elastic force, and may be electrically connected to the circuit board 123 embedded in the cover member 121, and the coupling member 126 may be provided to enable quick release.

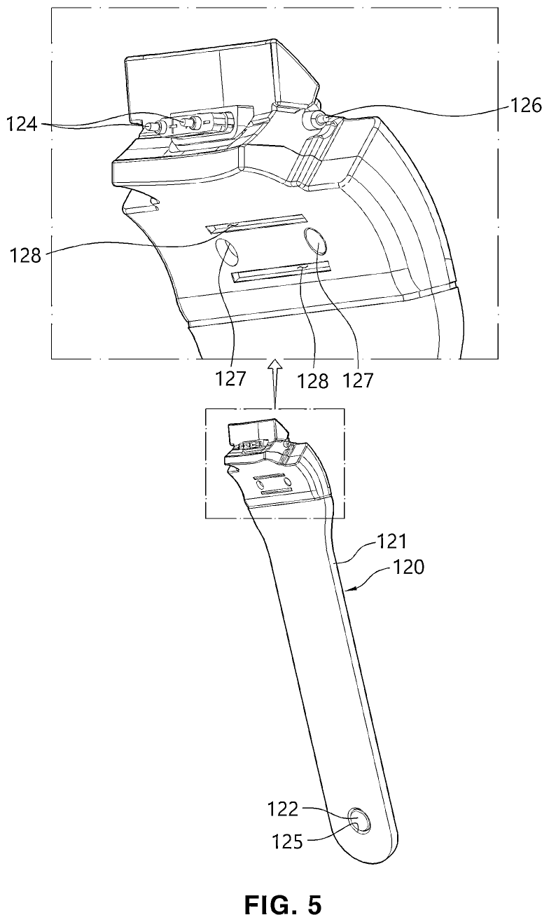

As a non-limiting example, as shown in FIG. 5, the pair of connection terminals 124 may be a known pogo pin, and the coupling member 126 may be a known lever-type spring bar.

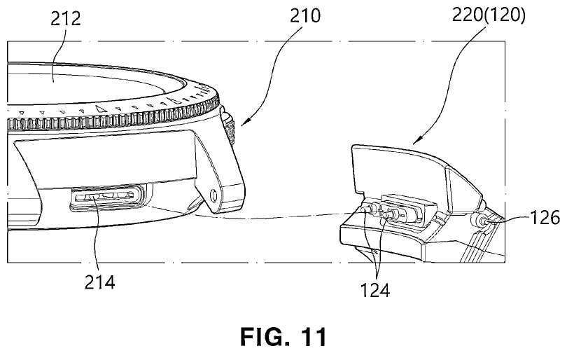

Accordingly, as shown in FIGS. 9 and 11, when the user fastens the second band 120 to the main body 210 of the smartwatch 200 through the coupling member 126, the pair of connection terminal 124 may be electrically connected to the main body 210.

Therefore, the power stored in the flexible battery 130 can be provided to the main body 210.

However, the connection terminal 124 is not limited to the pogo pin, and if any various known method can be employed as long as it can be electrically connected to the main body 210 of the smartwatch 200 through physical contact.

In addition, as long as the coupling member 126 can detachably couple the end of the second band 120 to one side of the main body 210, any various known coupling methods can be adopted.

Meanwhile, the flexible battery 130 embedded in the second band 120 can be recharged using power supplied from the outside.

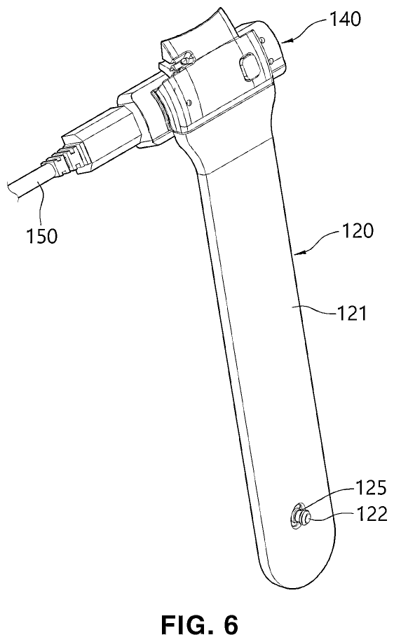

For example, the flexible battery 130 may be recharged through power provided from the charge cradle 140 in a state in which the second band 120 is coupled to the charge cradle 140, as shown in FIG. 6.

To this end, the second band 120 may include a charging terminal 127 for electrical connection with the charging cradle 140, and the charging cradle 140 may include a protruding terminal 143 that is in contact with and electrically connected to the charging terminal 127.

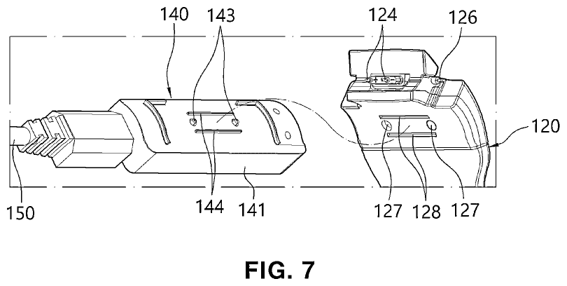

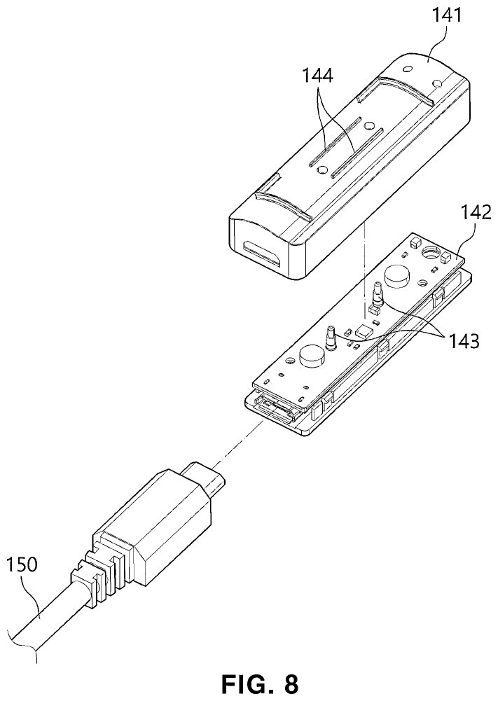

As a non-limiting example, the charging cradle 140 may include a body 141 having an internal space, a circuit board 142 disposed in the internal space, and a protruding terminal 143 protruding outward from one surface of the body 141 by a predetermined length while being electrically connected to the circuit board 142, as shown in FIGS. 7 and 8.

As a non-limiting example, the protruding terminal 143 may be a known pogo pin.

Herein, a charging circuit unit for recharging the flexible battery 130 may be mounted on the circuit board (142), and the charging cradle (140) may be directly connected to commercial power through a connection cable, but may receive power from the outside through a separate charging cable 150.

Accordingly, as shown in FIGS. 6 and 7, when the charging terminal 127 of the second band 120 and the protruding terminals 143 of the charging cradle 140 contact each other, the flexible battery 130 may be recharged using power provided from the charging cradle 140.

In this case, the second band 120 and the charging cradle 140 may include a protruding member 144 and an accommodating groove 128 corresponding to each other to maintain the coupled state of the body 141 and the second band 120 when the flexible battery 130 is charged.

For example, when the second band 120 and the body 141 are coupled, the accommodating groove 128 formed to be recessed inward may be formed on one surface of the second band 120, and the protruding member 144 protruding at a certain height may be provided on one surface of the body 141 facing one surface of the second band 120.

Accordingly, when the protruding member 144 is inserted into the accommodating groove 128 when the second band 120 and the body 141 are coupled, the protruding terminal 143 may be maintained in contact with the charging terminal 127, and the flexible battery 130 can be smoothly recharged using the power provided from the charging cradle 140.

However, the recharge method of the flexible battery 130 is not limited thereto, and a known wireless charging method may be applied, or power supplied from the outside may be directly supplied through a known charging cable without using the charging cradle 140.

Meanwhile, the watchband 100 for a smartwatch described above may be applied to the smartwatch 200.

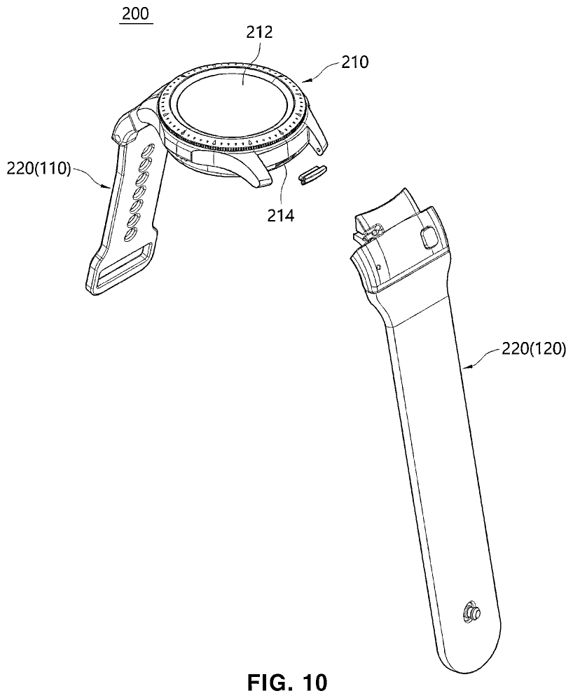

That is, as shown in FIGS. 9 and 10, the smartwatch 200 may include a main body 210 including a display unit 212 displaying at least one piece of information, and a band part 220 connected to the main body 210 and for maintaining a state in which the main body 210 is worn on the user's wrist.

Herein, the main body 210 may include a touch screen, a heart rate sensor, a communication module, a GPS function, etc., and may be linked to a portable device such as a smartphone or a tablet PC. In addition, the main body 210 may include any various known functions used in a known smartwatch, and may include any suitable sensors and components for performing various functions.

In this case, the band part 220 may be the watchband 100 for a smartwatch described above, and one side of the main body 210 may be provided with a connection port 214 to which the connection terminal 124 is coupled, as shown in FIGS. 10 and 11.

In addition, the connection port 214 may be an extra port previously formed for electrical connection with other electronic components in the main body 210 of a known smartwatch.

Herein, the watchband 100 for a smartwatch may include a first band 110 and a second band 120 as described above, and the details are the same as those described above, so detailed descriptions thereof will be omitted.

Accordingly, when the second band 120 is fastened to the main body 210 so that the connection terminal 124 of the second band 120 is connected to the connection port 214 as described above, the main body 210 may use power provided from the flexible battery 130 as driving power.

Therefore, since the main body 210 can be driven using power provided from the flexible battery 130, the total usage time of the main body 210 can be increased.

In addition, when using the watchband 100 for a smartwatch according to an embodiment of the present invention, the connection terminal 124 of the second band 120 is connected to an extra connection port 214 previously formed in the main body 210, so that the flexible battery 130 can be electrically connected to the main body 210 of the smartwatch. Therefore, the smartwatch 200 may receive driving power from the flexible battery 130 of the second band 120 without changing the design of the main body 210, thereby increasing the total usage time.

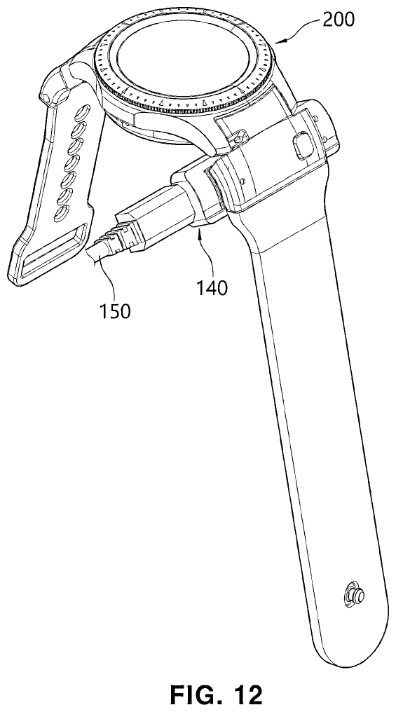

In addition, as shown in FIG. 12, the smartwatch 200 to which the watchband 100 for a smartwatch is applied may recharge the flexible battery 130 using the charging cradle 140 while the second band 120 is connected to the main body 210.

Although an embodiment of the present invention have been described above, the spirit of the present invention is not limited to the embodiment presented in the subject specification; and those skilled in the art who understands the spirit of the present invention will be able to easily suggest other embodiments through addition, changes, elimination, and the like of elements without departing from the scope of the same spirit, and such other embodiments will also fall within the scope of the present invention.

1. A watchband for a smartwatch including:
a first band made of a soft material having flexibility, formed from a plate-shaped member having a predetermined length, and having at least one positioning hole formed therethrough; and a second band including a cover member made of a soft material having flexibility, a flexible battery formed in a plate shape having a predetermined length and a predetermined area and embedded in the cover member, and a position-fixing fastening member fastened to the positioning hole,
wherein the flexible battery includes an electrode assembly, and an exterior material for packing the electrode assembly together with an electrolyte,
wherein the exterior material includes a first portion for packing the electrode assembly together with the electrolyte, and a second portion extended from the first portion by a predetermined length and to which the position-fixing fastening member is coupled.

2. The watchband for a smartwatch according to claim 1, wherein the cover member is provided to cover both outer surfaces of the first portion and the second portion, and the thickness of a portion corresponding to the flexible battery among the entire length of the second band is provided to have a constant thickness.

3. The watchband for a smartwatch according to claim 1, wherein the second band includes a fastening hole for fastening the position-fixing fastening member,
wherein the fastening hole is formed to penetrate both the cover member and the second portion of the flexible battery.

4. The watchband for a smartwatch according to claim 1, wherein the exterior material includes a first exterior material covering the upper surface of the electrode assembly and a second exterior material covering the lower surface of the electrode assembly,
wherein the first exterior material and the second exterior material is attached to each other through an adhesive layer disposed on one surface of each exterior material facing each other,
wherein the adhesive layer is disposed to surround an edge of the electrode assembly disposed between the first exterior material and second exterior material.

5. The watchband for a smartwatch according to claim 1, wherein the second portion functions as a shape-maintaining member to maintain the shape of the cover member and as a position-fixing member to prevent the position of the flexible battery built in the cover member from being changed inside the cover member.

6. The watchband for a smartwatch according to claim 1, wherein the second band further includes a connection terminal provided at one end to electrically connect the flexible battery and the main body of the smartwatch.

7. The watchband for a smartwatch according to claim 1, wherein the second band further includes a charging terminal for electrical connection with a charging cradle to recharge the flexible battery.

8. The watchband for a smartwatch according to claim 7, wherein the charging cradle includes a body and a protruding terminal protruding outward from one surface of the body, wherein the protruding terminal is a pogo pin that contacts the charging terminal when the second band and the body are coupled.

9. The watchband for a smartwatch according to claim 8, wherein a protruding member and an accommodating groove corresponding to each other are formed on one surface of the second band and one surface of the body facing each other when the second band and the body are coupled, respectively.

10. The watchband for a smartwatch according to claim 1, wherein the flexible battery includes:
a first pattern formed on the electrode assembly and a second pattern formed on the exterior material,
wherein each of the first pattern and the second pattern is formed such that peaks and valleys are repeatedly arranged along a longitudinal direction of the flexible battery, and
the first pattern and the second pattern is disposed such that peaks and valleys coincide with each other.

11. A smartwatch including:
a main body comprising a display unit displaying at least one piece of information; and a band part connected to the main body and for maintaining a state in which the main body is worn on the user's wrist,
wherein the band part is the watchband for a smartwatch according to claim 1, and
the main body receives driving power from the flexible battery.
